(19) United States
(12) Patent Application Publication
(10) Pub. No.: US 2014/0262166 A1
(43) Pub. Date: Sep. 18, 2014

(54) Waste Heat Recovery Apparatus for a Livestock Poultry Barn

(71) Applicant: Tingsheng Xu, Columbia, MO (US)

(72) Inventor: Tingsheng Xu, Columbia, MO (US)

(73) Assignee: THE CURATORS OF THE UNIVERSITY OF MISSOURI, Columbia, MO (US)

(21) Appl. No.: 14/172,893

(22) Filed: Feb. 4, 2014

(30) Foreign Application Priority Data
Feb. 6, 2013 (CN) 201320067905.1

(51) Int. Cl. A01K 1/00

(52) U.S. Cl. CPC A01K 1/0076
USPC 165/121

(57) ABSTRACT

Systems and method are provided for recovering heat from waste air being expelled from a livestock poultry barn. A heat recovery unit is specially designed to take advantage of an unused heat source, while avoiding the corrosive effects of waste air from the livestock poultry barn. The novel heat recovery capture heat from the expelled waste air.

### CROSS-REFERENCE TO RELATED APPLICATIONS

The present application claims priority from, and incorporates by reference in its entirety, Chinese patent application serial number 201320067905.1 filed Feb. 6, 2013.

### BACKGROUND

1. Field of the Invention

The present invention relates to livestock barn heating and cooling systems, and more specifically, to systems and methods of using a waste heat recovery system for a livestock poultry barn.

2. Description of Related Art

Commercial meat-bird poultry production in the U.S. includes broilers (chickens), turkeys and ducks. Commercial poultry farms raise thousands, and often many tens of thousands, of poultry birds inside large poultry barns. For example, a chicken being raised for human consumption spends its entire life indoors in a climate controlled atmosphere designed efficiently grow the birds to full, marketable size. Temperature control is a major factor in maintaining the climate controlled atmosphere for maximum efficiency. As such, fuel costs for heating are one of the major expenses in commercial poultry operations, typically the largest cost to poultry farmers aside from feed costs. Poultry barns are located rural areas where there is often no source of cheap fuel available. Propane, which is significantly more expensive than natural gas, is often the only option. Due to the unpredictable price of heating fuel—e.g., propane—a poultry farmer's ability to make a profit on a flock raised during the winter months is sometimes jeopardized by high fuel costs. Unexpected increases in fuel costs sometimes determines whether a given flock produces a profit or a loss for the farmer.

Health is another consideration affected by the climate controlled atmosphere of a poultry barn—both the health of the birds and the health of the human consumer who eventually purchases a bird for consumption. In addition, the climate controlled atmosphere of the poultry barn has a great effect on the weight gain efficiency of the flock as the birds grow from hatchlings into marketable sized broilers.

### SUMMARY

Embodiments disclosed herein address the above stated needs by providing systems and methods for a poultry barn waste heat recovery system. The present inventor recognized various characteristics specific to the commercial poultry industry. The novel embodiments disclosed herein take advantage of those various characteristics to reduce the fuel consumption for a commercial poultry operation utilizing heated indoor poultry barns.

Another embodiment provides a system and method of using a waste heat recovery system for a livestock barn with an enclosure containing at least three tube bundle cells. Each of the tube bundle cells has a pair of side panels, one on each side, connected by tubes that are aligned with holes in each of the side panels. The tube bundle cells are arranged in sequence within the enclosure to provide a waste air output path passing transversely through spaces between the tubes of each of the tube bundle cells which forms a waste air output path. A first fan is provided in the fresh air input path to move fresh air through the tubes, and a second fan is provide in the waste air output path to drive waste air through the spaces between the tubes of each tube bundle cell. The system is designed so that the fresh air input path crosses the waste air output path at least three times, helping to heat the fresh air using the heat of the waste air being expelled from the livestock barn.

### BRIEF DESCRIPTION OF THE DRAWINGS

The accompanying drawings, which are incorporated in and constitute part of the specification, illustrate various embodiments of the invheat recovery unitention. Together with the general description, the drawings serve to explain the principles of the invention. In the drawings:

FIG. 1A depicts a tube bundle cell of a heat recovery unit according to a first embodiment;

FIG. 1B depicts different cross-sections of tubes that can be used in various embodiments;

FIG. 1C depicts a tube pattern for a tube bundle cell that provides a straight through waste air output path;

FIG. 2A depicts a top view of a first configuration of a heat recovery unit and FIG. 2B depicts a top view and an oblique view of a single tube bundle cell;

FIG. 3 depicts a top view of a second configuration of a heat recovery unit;

FIG. 4 is an oblique view of an embodiment of a heat recovery unit;

FIG. 5 is an oblique view of a vertical installation embodiment of a heat recovery unit;

FIG. 6 is a flowchart depicting a method of using the heat recovery unit according to various embodiments disclosed herein; and

FIG. 7 is a cross-sectional view illustrating the heat forming of tube bundle cells from tubes and pairs of side panels.

### DETAILED DESCRIPTION

The climate of a poultry barn can be defined as the sum of environmental factors which influence the health and behavior of the flock. Climatic factors include temperature, humidity, air cleanliness, degree of light, and other such factors. The climate of a poultry barn has a great influence on the health of the birds as well as the efficiency of growing them to market size. Chickens raised in unfavorable climatic conditions are at risk to develop respiratory and digestive disorders and possibly exhibit behavioral issues. In addition to health and behavioral considerations, poor climatic conditions cause inefficiencies in feed utilization, thus reducing the daily rate of gain of the flock. In short, poultry raise in poor climatic conditions cannot be expected to perform optimally.

The present inventor recognized the interaction between the need for clean air in a poultry barn and the requirement to maintain a given temperature at various stages of poultry production. It typically takes seven to eight weeks to grow a hatchling broiler from several ounces up to a marketable weight of five to seven pounds. During this time the poultry barn is maintained at different heat levels, depending upon the age of the broilers. Young hatchling broilers require a much warmer environment than older, larger birds. When the flock is first introduced into the poultry barn the temperature is kept at around 85 to 90 degrees Fahrenheit for chickens, and around 90 to 95 degrees for turkeys. The temperatures are gradually reduced until reaching a final temperature of around 60 to 70 degrees Fahrenheit. During the winter months farmers spend a great deal of money on fuel costs to keep the barn heated to the initial temperatures which are as high as 90 degrees.

In order to keep the poultry barn air clean large fans, including side-wall fans and tunnel fans, are used to circulate the air, while constantly venting a portion of the dust ridden air out of the barn and replacing it with clean, fresh air from the outside. A problem with this is that, during the winter months in the Midwestern and northern states the clean, fresh air coming into the barn is too cold for optimal climactic conditions. Therefore, it is necessary to constantly heat the barn to compensate for the incoming clean, fresh air being introduced into the barn's climate. With conventional climate control systems energy consumption and the associated costs for poultry farms is second only to feed costs. Various embodiments capitalize on the heat being expelled with the dirty air, using heat recovery units to capture part of that heat for the incoming fresh air.

Heat recovery systems are used in other fields of industry, including implementations to recover at least some of the waste heat being vented from factories and office buildings. Typically, the conventional heat recovery systems use a metal heat exchanger unit since metal interface surfaces tends to conduct heat more efficiently than plastics, vinyls, and other non-metallic synthetic materials. However, the present inventor recognized a characteristics specific to the poultry industry that would pose a drawback in attempting to use a conventional metal heat recovery systems for expelled poultry barn air. The expelled air from poultry barns is quite dirty, containing a high concentration of dust, feathers and other airborne particles as well as ammonia. Ammonia and other gases in a poultry barn are quite corrosive to conventional metallic heat recovery systems. Moreover, the airborne particles include dust from dried poultry feces, a material that is quite corrosive and often includes viruses, bacterial content and parasites. The pollutants in poultry barn air—in particular, the feces dust, feathers and feather parts—result in an airborne pollutant that is very lightweight, somewhat sticky, and prone to causing diseases in poultry and humans. The poor quality of air, including airborne feces dust, feathers and feather parts, renders conventional metal heat recovery systems unsatisfactory for poultry barns. Conventional heat recovery systems with high efficiency metal interfaces quickly build up a layer of dirt and grime from airborne dust, feces dust, feathers and feather parts, and even fly manure. This is especially true of conventional heat recovery units that use closely spaced fins to more efficiently translate the heat from one air stream to another. The buildup of grime and impurities, in turn, corrodes the surface area of conventional heat recovery systems which lowers the heat exchange efficiency, results in reduced air flow, and in some cases, can even cause air flow blockages.

Meat poultry is raised in flocks consisting of birds of the same age. Hatchlings are introduced into a barn at a young age, generally in sufficient quantities to populate the entire barn. In many operations, the birds remain together for approximately five to eight weeks—the time it takes to reach marketable weight and size. To avoid propagating disease from one flock to the next, farmers thoroughly clean out the poultry barn from top to bottom after a flock is sold out of it. The cleaning typically is done by scrubbing and using high pressure water streams to remove viruses, bacteria, fungi, and parasites. In addition the post-flock cleaning generally involves the use of strong soaps and chemical solvents such as Stalosan F, Net Tex Viratec, Poultry Shield, and other such commercially available poultry barn cleaners known to those of ordinary skill in the art. Commercial poultry barn cleaning agents typically include one or more of the following types of disinfectants in various concentrations: aldehydes (e.g., formalin, formaldehyde, glutaraldehyde); chlorine-releasing agents (e.g., sodium hypochlorite, chlorine dioxide, sodium dichloroisocyanurate, chloramine-T); iodophors (e.g., povidone-iodine, poloxamer-iodine); phenols and bis-phenols (e.g., triclosan and hexachlorophene); quaternary ammonium compounds and peroxygens (e.g., hydrogen peroxide and peracetic acid).

The thorough post-flock clean is performed to kill any viruses, bacteria, fungi, and parasites present in the poultry barn after the flock is sold. An attempt to use a conventional metallic heat recovery system would prove problematic in view of the rigorous post-flock poultry barn cleaning. Many of the aforementioned chemical solvents and disinfectants used to clean poultry barns are corrosive to metals used in conventional metallic heat recovery systems. Moreover, in addition to corrosion caused by the chemical cleaners and disinfectants, conventional metallic heat recovery systems would tend to corrode over time due to the pollutants that are specific to the meat poultry industry—that is, due to the feces dust, feathers and feather parts from a poultry flock. Once a conventional metallic heat recovery system begins to corrode it becomes nearly impossible to clean it sufficiently for the purposes of a commercial meat poultry barn. The one known commercial alternative would be to use conventional metallic heat recovery systems constructed of stainless steel. This, however, would be cost prohibitive and impractical for a commercial meat poultry operation. Stainless steel is quite expensive and would be difficult to work with in order to tailor fit it to a particular poultry barn.

To avoid the drawbacks of conventional systems, various embodiments disclosed herein include configurations that minimize the effect of polluted poultry barn air including feathers. Moreover, the various embodiments may be configured from plastics, polymers or other such synthetic materials that are less susceptible to dirt, grime and feather buildup than metal surfaces. For example, some embodiments are constructed partially, or wholly from non-metallic synthetic materials such as high-density polyethylene (HDPE). Other suitable synthetic materials include polyvinyl chloride (PVC), polypropylene, or medium-density polyethylene (MDPE)), polystyrene, or other such non-metallic synthetic materials. The various embodiments of the heat recovery units are constructed from non-metallic synthetic materials that are also resistant to rust and corrosion caused by chemical poultry barn cleaners and disinfectants. Finally, the design of the various embodiments features removable access panels that cover access holes, or doorways, to facilitate cleaning the waste air output paths.

FIG. 1A depicts a tube bundle cell 100 of a heat recovery unit according to a first embodiment. The tube bundle cell of this embodiment includes a predetermined number of non-metallic synthetic tubes 101 arranged substantially parallel to each other. By “substantially parallel” it is meant that the largest distance between the two tubes is not more than double the average distance between the two tubes. In this embodiment the tubes 101 are configured in a symmetrical honeycomb pattern. In other embodiments the tubes 101 may be arranged in an elongated honeycomb pattern—that is, vertically elongated with fewer tubes spaced out farther apart in each column or else horizontally elongated with the columns of tubes being spaced farther apart. An elongated honeycomb pattern may allow a brush, pressured flushing jet, or other cleaning tools, to be inserted between the columns of tube (or rows of tubes), thus facilitating the cleaning of the tubes 101. In other embodiments the tubes 101 may be arranged in various geometric patterns, or randomly, so long as there is space between the tubes 101 sufficient for waste air from the poultry barn to pass in the direction 103 between the tubes 101. Clean air headed into the barn passes insides the tubes 101 in direction 105 (or in some instances, in the opposite direction of 105).

The tubes 101 may be arrange at varying distances apart, depending upon the particularities of the installation. (FIG. 2B depicts the tube spacing 253.) For example, in some embodiments using relatively small tubes the outer surfaces of the tubes may be spaced as closely together as ⅛ inches, on average. In other embodiments using larger tubes the tube spacing may be as great as 6 inches apart, on average. The tube spacing is often referred to in terms of the average tube spacing being within a given range, for example, any range within the minimum spacing distance of ⅛ inches to the maximum spacing distance of 6 inches, e.g., an average spacing distance of 0.9 inches to 1.1 inches, 0.65 to 0.85 or 1.5 inches to 2.25 inches, or other like ranges within the minimum and maximum specified above. In a typical installation it is more common for the tube spacing to be, on average, within the range of ½ inches to 2 inches, on average. For example, an average tube spacing—that is, the distance between the outer surface of two adjacent tubes—is ¾ inches.

In some embodiments the tubes 101 are arranged such that there is no straight through path for the outgoing waste air to pass in direction 103 without contacting, or flowing around, at least some of the tubes 101. For example, in the honeycomb pattern depicted in FIG. 1A the air must curve somewhat to flow between any two given tubes and then either above or below the next tube in the outgoing waste air output path. This is because for any two given consecutive tubes 101 in any particular column, there is a tube in the adjacent column aligned horizontally (in direction 103) within the gap between the two given consecutive tubes 101. Providing a path where the air must travel around the various tubes in order to flow in a direction 103 along the outgoing waste air output path ensures that the outgoing air will either contact or flow around the tubes, thus more efficiently passing its heat to the tubes, and in turn, to the incoming cold air within the tubes 101. In other embodiments the tubes 101 are arranged in straight rows as shown in FIG. 1C, rather than arranging the tubes in a honeycomb pattern or otherwise being offset from one column of tubes to the next. The straight-row arrangement of FIG. 1C provides an unobstructed waste air output path through the heat recovery unit, thus reducing the pressure needed to drive output waste air through the system. As a result, a smaller output fan may be used in these embodiments featuring an unobstructed output waste air output path.

The tube bundle cell 100 includes two parallel side panels 107 and 109. Each of the side panels 107 and 109 has an outer face defining the outside of the tube bundle cell 100 and an inner face, with the tubes 101 spanning from the inner face of side panel 107 to the inner face of side panel 109. The side panels 107 and 109 each have holes from the outer face through to the inner face, each hole corresponding to one of the tubes 101. In the embodiment of FIG. 1A clean air travels in direction 105, passing through a hole in side panel 107, through the tube 101 aligned with the hole, and out of a corresponding hole in side panel 109. In the embodiment depicted in FIG. 1A the tubes 101 are straight along the direction that the clean air travels, that is, direction 105. However, in alternative embodiments the tubes 101 may be curved, angled, or otherwise shaped in a manner that is not straight.

In the embodiment depicted in FIG. 1A the tubes 101 have a circular cross-section. FIG. 1B depicts a sampling of some of the different cross-sections of tubes that can be used in various embodiments. In some embodiments the tubes may have an elliptical cross-section 115, an elongated oval cross-section 117, a square cross-section or diamond cross-section 119. In addition, the tubes may be oriented with the elliptical cross-section 115 or elongated oval cross-section 117 positioned in any direction rather than with up/down or side-to-side. Various other embodiments may be implemented using a non-symmetrical cross-section, or other shaped cross-section as would be known to those of ordinary skill in the art. The tubes 101 are typically fastened to each of the side panels 107 and 109 in a manner that is substantially airtight to create a fresh air input path for the fresh incoming air and prevent the outgoing air from leaking back into the barn. By “substantially airtight” it is meant that a stream of air blown at a pressure of 0.2 inch of water column into the holes of side panel 107, pass through the tubes 101, and exit the corresponding holes of panel 109 with less than 10% leakage of the air. In some embodiments the tubes 101 are fastened to each of the side panels 107 and 109 by heating the respective pieces and pressing them together to form a substantially airtight seal. That is, for selected non-metallic materials such as polyethylene (PE), a thermal fusion method can be used to connect the tubes 101 to the side panels 107 and 109.

Each of the side panels 107 and 109 may be configured with a frame 111 around the outer edge. The frame 111 provides structural support and aids in sealing the side panels 107 and 109 when the tube bundle cell 100 is inserted into a heat recovery unit. In some embodiments the frame 111 is made of the same non-metallic synthetic material as the tubes 101, while in other embodiments the frame may be made of metal or another material for increased structural support. In some embodiments the frame 111 may have a gasket-like material positioned near its edges to aid in making a substantially airtight seal when the tube bundle cell 100 is inserted into a heat recovery unit.

FIG. 2A depicts a top view of a first configuration of a heat recovery unit 200. Fresh air—for example, air from outside a poultry barn—enters the heat recovery unit 200 at fresh air inlet 215. This configuration of the heat recovery unit 200 has five tube bundle cells 201, 203, 205, 207 and 209. Depending upon the requirements of the system, a heat recovery unit 200 may be configured with any number of tube bundle cells, for example, from one tube bundle cell to eleven or more tube bundle cells. The tube bundle cell 100 embodiment depicted in FIG. 1A is constructed with alternating columns of 21 tubes and 20 tubes, and has 349 tubes in total. Another embodiment has alternating columns of six tubes and five tubes, for a total of 61 tubes in each tube cell bundle. Depending upon the requirements of the implementation the number of tubes per tube bundle cell may vary from as few as three tubes to as many as ten thousand tubes. The number of tubes depends largely upon the size of the heat recovery unit, and the materials used to construct it. The tubes 101 can be as small as ⅛ inch outside diameter in some embodiments, while other embodiments may be constructed from tubes 101 of up to eight inches in diameter.

FIG. 2B depicts a top view of a single tube bundle cell 251, and an oblique view of a tube bundle cell 261. The tube bundle cell 261 is shown with only one frame 263, although a tube bundle cell generally has two frames—one on either end of the tubes to keep the tubes in place. The frame also aids in providing a substantially airtight seal when the tube bundle cell 100 is inserted into a heat recovery unit. The embodiment depicted in FIG. 2B has only thirty three tubes per tube bundle cell, three columns of seven tubes each and two columns of six tubes.

The tube bundle cells 201-209 are inserted into the heat recovery unit 200 via the access holes provided to receive the tube bundle cells. In some embodiments the access holes are located on top of the heat recovery unit 200. The access holes are then covered with access panels to provide a substantially airtight seal. Each of the tube bundle cells 201-209 has an air entry compartment. For example, air flowing into the fresh air inlet 215 enters air entry compartment 221 which is associated with tube bundle cell 201. The air flowing into air entry compartment 221 can enter any of the tubes of tube bundle cell 201. In this way, if any of the tubes of tube bundle cell 201 becomes obstructed the air can simply flow through the other tubes at a slightly higher rate than if all tubes were completely unobstructed.

Each air entry compartment has air dividers to contain the air flow and direct it from one tube bundle cell to the next. For example, air entry compartment 225 has air dividers 217 and 219. These air dividers direct the air coming out of tube bundle cell 203 in the direction of the air and back into tube bundle cell 205. The air divider 217 is configured with guide groove 213. The first tube bundle cell 201 is held in place at one corner by guide groove 213. Each of the tube bundle cells 201-209 is inserted through its respective access hole of the enclosure covering the heat recovery unit 200 so that the frames of the tube bundle cells line up with the guide grooves of the heat recovery unit's enclosure. The frames are dimensioned to fit snugly within the guide grooves so as to provide a substantially airtight seal. The frames slide into the guide groove 213 in a manner akin to a sliding glass window of a house sliding within its window frame. The tube bundle cells are arranged in sequence so as to create a substantially airtight fresh air input path through the tubes of the tube bundle cells. Insertion of the tube bundle cells in the groove guides of the enclosure also creates a waste air output path for the warm waste air to flow transversely through the spaces between the tubes of each tube bundle cell.

The path of the air flow through the heat recovery unit 200 is as follows: The air flows through the tubes of one tube bundle cell and out into the air entry compartment of the next tube bundle cell, and then the air flows into the tubes of that next tube bundle cell and out into the air entry compartment of the next tube bundle cell. For example, the air flows through the tubes of tube bundle cell 201 and out into the air entry compartment 223 of tube bundle cell 203. This allows the air to flow from tube bundle cell 201 in the direction of the arrows in air entry compartment 223 and then into tube bundle cell 203. Routing air along the incoming fresh air path in this manner allows the colder incoming fresh air to cross the path of the heated outgoing waste air once for each tube bundle cells in the heat recovery unit 200. For example, there are five tube bundle cells 201-209 arrange in sequence along the incoming fresh air input path: tube bundle cells 201, 203, 205, 207 and 209. Since the waste air output path flows transversely through the spaces between the tubes of each tube bundle cell, each time the fresh air flows through the tubes of a tube bundle cell the fresh air input path is said to cross the waste air output path. This can be seen in FIG. 2A. The waste air output path flows in direction 235 from filter 237 through the spaces between the tubes of each tube bundle cell and out of the heat recovery unit 200 near output fan 233. The fresh air flows into the heat recovery unit 200 at fresh air inlet 215, then back and forth through tube bundle cells 201, 203, 205, 207 and 209, and out of the heat recovery unit 200 near input fan 231. In this way, the fresh air is said to cross the path of the waste air five times—once for each of tube bundle cells 201, 203, 205, 207 and 209.

Once the fresh air has made its way through the sequence of tube bundle cells 201-209 it is blown by input fan 231 into the poultry barn fresh air vent system, or in some instances, directly into the poultry barn. Depending upon the specifics of the configuration the input fan 231 may instead be positioned at the beginning of the sequence of tube bundle cells 201-209, just ahead of air entry compartment 221. In other configurations the input fan 231 may be positioned at a point with the sequence of tube bundle cells 201-209—for example, between tube bundle cell 207 and tube bundle cell 209 (or any other two consecutive tube bundle cells). The input fan 231 may be any of various types of fans such as a propeller blade fan, a squirrel cage fan (sometimes called a centrifugal fan), an axial fan (e.g., a vane_axial fan), or other like type of fan. In one embodiment a variable frequency drive (VFD) fan is used so that the volume of blown air can be adjusted to suit the parameters of the poultry barn. Alternatively, either a variable speed fan or a variable pitch axial (VPA) fan may be used, or any other type of adjustable rate fan as are known by those of ordinary skill in the art.

The incoming fresh air flow is directed through the tube bundle cells 201-209 in order to heat the incoming fresh air. The source of heat is the outgoing, waste air from the poultry barn. Each of the tube bundle cells 201-209 serves as a heat exchanger between the cold, incoming air and the heated output waste air. Referring back to FIG. 1A, the waste air is blown between the tubes of each tube bundle cell (e.g., in direction 103) while the incoming fresh air is routed through the tubes themselves (e.g. direction 105). Heat is exchanged each time the fresh air passes through one of the tube bundle cells 201-209, acting to heat the incoming fresh air and cool down the outgoing waste air. The outgoing waste air passes through a filter 237 as it exits the poultry barn before passing through the tube bundle cells 201-209. The filter 237 may be embodied as a reusable mesh grid filter that can be cleaned off and reused. Mesh grids, or screens, may be used to cover the fresh air inlet and/or the waste air inlet. For example, FIG. 2A depicts filter 237 positioned at the waste air inlet of embodiment 200. In other embodiments the filter 237 is embodied as a replaceable paper filter akin to the filters used in home and commercial heating/cooling systems. Alternatively, the filter 237 may be a screen or grid that filters out at least some of the particles and features from the waste air, while serving the dual purpose of a safety screen covering the waste air inlet. In yet other embodiments the filter may be a liquid based filter that bubbles air through a layer of water or other liquid in order to capture and remove airborne particles. In some embodiments the filter 237 may be positioned at a different point in the output waste air flow, e.g., near the output by output fan 233. In other embodiments the filter 237 may be omitted from the system.

The filter 237 prevents expelling flies, dust, feathers and other airborne particles from the poultry barn. The filter 237 also aids in reducing the buildup of dirt, grime and feathers in the tube bundle cells 201-209. The output waste air is pulled through waste air output path in direction 235 by output fan 233. Depending upon the specifics of the poultry barn configuration, the output fan 233 may be the same size and/or type of fan as input fan 231, or a different size and/or type of fan. Some embodiments are configured with a slightly larger input 231 than the output fan 233 so as to keep a slight amount of pressure in the poultry barn (or alternatively, the same sized fans are used with the input fan 231 being set to blow at a greater rate). Keeping a slight positive pressure in the poultry barn aids in preventing cold air from leaking into the barn, e.g., through gaps in the doors and windows of the barn.

It should be noted that the stream of fresh input air passes through multiple, consecutive tube bundle cells 201-209, with heat being exchanged each time the fresh air passes through one of the tube bundle cells 201-209. Since the same stream of output waste air is blown through the output path, the output waste air cools somewhat as it passes through each consecutive tube bundle cells 201-209. In the embodiment 200 depicted in FIG. 2A the output waste air enters the system at the right, near filter 237, and exits the system at the left, near output fan 233. On the other hand, the fresh input air enters the system depicted in the figure on the left, at air entry compartment 221, and then exits the system towards the right, at input fan 231. The effect of this orientation is that the hottest output waste air—the output waste air entering the system at filter 237—exchanges heat with the fresh input air at its warmest point, that is, after the fresh input air has already passed through tube bundle cells 201-207. The output waste air exiting the system at tube bundle cell 201 near the output fan 233 is at its coolest, having already passed through the other four tube bundle cells. Thus, the output waste air at its coolest exchanges heat with the fresh input air at its coolest point, that is, as the fresh input air enters the system at air entry compartment 221 which feeds into tube bundle cell 201. Configuring the system in this manner of counter-current flow maintains a more consistent temperature differential between the input air stream and the output air stream. This provides a more even, efficient transfer of heat from the output air stream to the input air stream. In addition, minimizing the temperature differential between the input air stream flowing through the inside of the tubes and the output air stream flowing out around the tubes tends to reduce the structural strain due to material expansion and contraction caused by flowing hot and cold air.

The outer walls of heat recovery unit 200 forming an enclosure 239 that may be insulated to prevent heat loss. In some embodiments the fans 231 and 233 are positioned within the insulated walls of heat recovery unit 200. In other embodiments one or both of the fans 231 and 233 may be positioned outside the insulated walls of heat recovery unit 200. For example, the output fan 233 may be positioned between the poultry barn and the heat recovery unit 200, with an air duct connecting the barn, the output fan 233 and the heat recovery unit 200. In such a configuration with the output fan 233 positioned between the poultry barn and the heat recovery unit 200 it is desirable to provide an insulated container for the fan 233 as well as an insulated duct connecting the components since the output air flowing into the fan 233 at that point contains a considerable amount of heat. However, if the output fan 233 is positioned after tube bundle cell 201 its container and venting does not need to be insulated since any residual heat in the air at that point will simply be released into the atmosphere. Similarly, if the input fan 231 is located between the heat recovery unit 200 and the poultry barn as shown in FIG. 2A it is desirable to provide the input fan 231 with an insulated container and insulated duct work. On the other hand, if the input fan 231 is configured outside the fresh air entry point of the heat recovery unit 200 then there is no need to insulate its container or duct work.

FIG. 3 depicts an alternative configuration of the heat recovery unit. The tube bundles are parallel to each other, but the side panels are not perpendicular to tubes. This allows a different shape of air entry compartment. In FIG. 2A the air entry compartments (e.g., air entry compartment 221) are rectangular. But in the embodiment depicted in FIG. 3 the air entry compartments (e.g., air entry compartment 321) are triangular in shape. This embodiment allows same amount of air pass through for a given pressure, but reduces the size of the unit by a small amount.

FIG. 4 is depicts an oblique view of a heat recovery unit 400 according to various embodiments disclosed herein. The figure shows further details of the access holes and access panels covering the access holes. As shown in the figure the heat recovery unit 400 may be embodied with an access hole 411 through which a tube bundle cells may be inserted into the enclosure. The access holes are quite useful for accessing the waste air output path to perform the periodic cleaning that is required between flocks. Typically, each of the tube bundle cells has an access hole accessing it, and an associated access panel to cover the access hole. For example, in the embodiment depicted there is a tube bundle cell beneath each of the access panels 401, 403, 405, 407 and 409. The fresh air input path is denoted by dotted line 425, and travels from the fresh air inlet at arrow 419 to the fresh air outlet 417 which is typically connected to ventilation going into the poultry barn. The waste air output path travels from the waste air inlet at arrow 421 to the waste air outlet 423.

The air entry compartment 413 receives input air from the tube bundle cell beneath access panel 403 and routes it back into the tube bundle cell beneath access panel 401.

In some embodiments the access holes may be configured on the sides of the heat recovery unit 400 rather than the top. The heat recovery unit 400 of FIG. 4 is configured with guide grooves which line up with the access holes to receive the frames of the tube bundle cells. This allows the tube bundle cells (e.g., 201-209 of FIG. 2A) to be installed into the heat recovery unit 400 through the access holes 401, 403, 405, 407 and 409.

The enclosure of the heat recovery unit 400, that is, the framework and outer layer of panels and coverings, may, in some embodiments, be configured as modular units that can be taken apart for transportation and then assembled on site. For example, in some embodiments the various air entry compartments may be removed, revealing portions of the enclosure covering each tube bundle cell that can be taken apart for repair or transportation. The modular configuration also allows the heat recovery unit 400 to be reconfigured in any number of sizes—that is, with any number of tube bundle cell—in order to configure the heat recovery unit 400 to closely match the needs of a given poultry growing operation.

FIG. 5 is an oblique cut away view of a vertical installation embodiment heat recovery unit. In some instances the space constraints of the poultry farm make it desirable to implement the heat recovery unit with a minimal horizontal footprint. For example, it is sometimes the case where the poultry barn sits next to a road, another building, or other such obstruction and there simply isn't room to lay the heat recovery unit in a horizontal configuration. In other instances, there is plenty of room to implement either a horizontal configuration or a vertical configuration, but it is desired to pull in fresh air and/or vent the waste air at a point somewhat above ground level. In both of these situations the vertical oriented embodiment 500 of FIG. 5 provides an apt solution.

In the vertical installation of FIG. 5 the fresh input air enters fresh air inlet 501 in direction 503. The input path is defined by dotted line 505. As shown in the figure, the fresh input air passes through the top tube bundle cell, into entry compartment 507, into the middle tube bundle cell, into entry compartment 509. Upon passing through entry compartment 509 the fresh input air passes through bottom tube bundle cell 511 and out of the vertical installation heat recovery unit 500 into the poultry barn. (FIG. 5 shows details of the tubes of bottom tube bundle cell 511, for the sake of illustration.) In the embodiment depicted the output waste air enters the bottom of vertical installation heat recovery unit 500 and travels transversely along the output waste air path 513 through the spaces formed between the tubes of the three tube bundle cells. In some vertical installation embodiments the heat recovery unit 500 is mounted on legs or supporters 515 so as to keep the unit off the ground so waste air can be directed into the unit from beneath. In other configurations the waste air inlet may be configured from the side of heat recovery unit 500 rather than from the bottom. Although the embodiment 500 is shown with three tube bundle cells, in practice this configuration may be constructed with any number of tube bundle cells so as to suit the particular needs of a given poultry barn, e.g., five tube bundle cells, eight tube bundle cells, fifteen tube bundle cell, etc.

FIG. 6 is a flowchart depicting a method of using the heat recovery unit according to various embodiments disclosed herein. The method begins at block 601 and proceeds to 603 where an enclosure is configured to receive and hold the plurality of tube bundle cells. In block 605 two side panels are provided for each tube bundle cell. Although various embodiments feature a wide range of the number of holes, the embodiment illustrated in FIG. 6 has at least 61 holes each side panel. In block 607 tubes are fastened between corresponding holes and secured in a substantially airtight manner. In block 609 a frame is provided around the edges of each side panel.

In block 611 guide grooves are provided in the enclosure in a position which enables the guide grooves to receive the side panels as they are inserted through the various access holes. The frames mate up with guide grooves when the tube bundle cells are inserted into an enclosure, creating a substantially airtight fresh air input path and waste air output path. In block 613 each of the tube bundle cells is inserted into the enclosure, connecting them sequentially to provide a substantially airtight fresh air path. In block 615 an input fan is provide for the fresh air path and an output fan for the waste air path. In block 617 a vent from inside the poultry barn is connected to the waste air path, and an input inlet is opened to the fresh air path. In block 619 the output fan is turn on to vent heated waste air from inside the poultry barn to the waste air path. In block 621 In block 619 the input fan is turned on to route fresh air into the input inlet and through the tubes along the to the fresh air path, thus heating the input air by capturing heat from the waste air being expelled from the poultry barn.

Various activities may be included or excluded as described above, or performed in a different order, while still remaining within the scope of at least one of the various embodiments. For example, block 603 describes providing an enclosure configured to receive and hold the plurality of tube bundle cells while blocks 605-609 describe providing the side panels, fastening the tubes and providing a frame around each of the tube bundle cells. In some instances the activities of blocks 605-609 can be performed prior to the activities of block 605. Other steps or activities of the methods disclosed herein may be omitted or performed in a different manner while remaining within the intended scope of the claimed embodiments and embodiments disclosed herein.

FIG. 7 illustrates a method of heat forming the tube bundle cells from tubes and pairs of side panels. As shown in the figure the tubes 705 to be formed into bundles are placed in a tube holder template 701 configured to hold the tubes 705 in the proper position and spacing for a tube bundle cell. The tube holder template 701 is maneuvered to hold the tubes 705 over a tray of melted plastic 703 (or other material being used) for the side panels. Typically, the plastic is heated beyond its melting point, either in the pan or in a heating receptacle and then poured in the pan. The tube holder template 701 holding the tubes 705 is then lowered to press the tubes 705 firmly through the melted plastic 703 until the tubes 705 touch the bottom of the tray through the melted plastic 703. This action typically drives some of the plastic up into the tubes 705, forming plugs within the tubes. The plugs must then be removed to complete the process of heat forming the tube bundle cell. One way of doing this is to wait until the plugs have hardened, and then dig the plugs out of each tube. Another method is to used compressed air to blow the plugs out of each tube, either while the plastic 709 remains somewhat soft or after it has cooled down and is easier to work with. Yet another method is to insert plugs 707 of wood, metal or another substance into each tube before pressing the tubes 705 into the melted plastic 703. In this way the wood or metal plugs 707 prevent melted plastic from entering the tubes, and the metal or wood plugs 707 can easily be removed once the tubes 705 have been bonded with the melted plastic 709. Once the plugs 707 are removed a small amount of waste plastic may need to be trimmed away from the holes to ensure unobstructed passages for the fresh air to be routed through the tubes 705.

The various embodiments are discussed throughout this disclosure in terms of a waste heat recovery system for a livestock poultry barn for illustrative purposes. In various embodiments the waste heat recovery system may be implemented in other types of livestock barns, including but not limited to cattle barns, hog barns, sheep barns, horse barns or other types of livestock as are known by those by ordinary skill in the art.

Air flowing “through” a tube enters one end of the tube, passes through the length of the tube, and exits the other end of the tube. Air passing “transversely” through a space formed between two tubes (which are spaced apart, e.g., parallel) passes over the outer surfaces facing each other of the two tubes, and in between the respective endpoints of the two tubes.

The term “substantially airtight gaseous path” as this term applies to two or more interconnected parts means that a gas such as air can flow through the parts at an input insertion pressure of 2 PSI without more than 10% of the gas (e.g., air) leaking out before reaching the output of the interconnected parts. For example, given a continuous flow of air into the input of two interconnected parts forming a substantially airtight gaseous path, if 100 cubic meters of air is injected at 2 PSI into the input, then at least 90 cubic meters of air will flow from the output of the two interconnected parts.

The term “gaseous communication” as this term is applied herein to interconnected parts means that a gas such as air can flow through two interconnected parts. For example, in an embodiment disclosed herein with a fresh air input in gaseous communication with a fresh air output, there is a gaseous pathway through which air may flow.

The description of the various embodiments provided above is illustrative in nature inasmuch as it is not intended to limit the invention, its application, or uses. Thus, variations that do not depart from the intents or purposes of the invention are intended to be encompassed by the various embodiments of the present invention. Such variations are not to be regarded as a departure from the intended scope of the present invention.

What is claimed is:

1. A waste heat recovery system for a livestock barn comprising:
at least three first side panels and at least three second side panels, each of said first and second side panels having a plurality of holes comprising at least thirteen holes from an inner face through to an outer face, and each of said first and second side panels having at least four edges bounding the inner face and the outer face;
a plurality of tube bundle cells comprising at least three tube bundle cells, each of the plurality of tube bundle cells comprising one of the first side panels and one of the second side panels, each of the plurality of tube bundle cells further comprising a plurality of tubes which respectively connect each of the plurality of holes of said one of the first side panels to each of the plurality of holes of said one of the second side panels;
an enclosure configured to receive and hold the plurality of tube bundle cells in a sequential arrangement that provides a fresh air input path through each of the plurality of tube bundle cells in sequence;
a first fan positioned within the fresh air input path;
a second fan positioned within a waste air output path;
wherein the plurality of tube bundle cells is arranged within said enclosure to provide the waste air output path passing transversely through spaces between the plurality of tubes of each of said at least three tube sets; and
wherein the fresh air input path crosses the waste air output path at least three times.

2. The waste heat recovery system of claim of claim 1, wherein the livestock barn is a livestock poultry barn, the system further comprising:
a first frame configured as part of each of the plurality of tube bundle cells, the first frame being connected to the at least four edges of the first side panels; and
a second frame configured as part of each of the plurality of tube bundle cells, the second frame being connected to the at least four edges of the second side panels;

3. The waste heat recovery system of claim of claim 2, further comprising:
first guide grooves configured as part of the enclosure and arranged to receive and hold the first frames of the plurality of tube bundle cells, providing a substantially airtight seal between the fresh air input path and the waste air output path; and
second guide grooves configured as part of the enclosure and arranged to receive and hold the second frames of the plurality of tube bundle cells, providing a substantially airtight seal between the fresh air input path and the waste air output path.

4. The waste heat recovery system of claim of claim 3, further comprising:
a filter provided in the waste air output path at a point before waste air;
wherein the enclosure is modular and may be disassembled into a number of pieces equal to or greater than a number of tube bundle cells in the plurality of tube bundle cells.

5. The waste heat recovery system of claim of claim 1, wherein each of the plurality of tube bundle cells comprises at least sixty-one tubes; and
wherein an average tube spacing of the at least sixty-one tubes is from 0.65 to 0.85 inches apart.

6. The waste heat recovery system of claim of claim 1, wherein the plurality of tube bundle cells comprises tubes made from a non-metallic synthetic material.

7. The waste heat recovery system of claim of claim 6, wherein the non-metallic synthetic material is resistant to corrosion due to poultry feces, feathers and feather parts.

8. The waste heat recovery system of claim of claim 7, wherein the non-metallic synthetic material is resistant to corrosion due to cleaning agents and disinfectants including aldehydes, chlorine-releasing agents, iodophors, phenols and bis-phenols, quaternary ammonium compounds and peroxygens.

9. A method of recovering waste heat for a livestock barn, the method comprising:
providing a plurality of tube bundle cells comprising at least three tube bundle cells;
providing at least three first side panels and at least three second side panels, each of said first and second side panels having a plurality of holes comprising at least thirteen holes, and each of the plurality of tube bundle cells being associated with one of the first side panels and one of the second side panels;
connecting a tube of each of the plurality of tube bundle cells from each hole in the plurality of holes in the first side panels to each corresponding hole in the plurality of holes in the second side panels;
configuring an enclosure to receive and hold the plurality of tube bundle cells comprising at least three tube bundle cells, wherein the enclosure is configured to receive and hold the plurality of tube bundle cells in a sequential arrangement that provides a fresh air input path through each of the plurality of tube bundle cells in sequence;
providing a first fan positioned within the fresh air input path to blow fresh air into the livestock barn;
providing a second fan positioned within a waste air output path to blow waste air out of the livestock barn;
wherein the plurality of tube bundle cells is arranged within said enclosure to provide the waste air output path passing transversely through spaces between the plurality of tubes of each of said at least three tube sets; and
wherein the fresh air input path crosses the waste air output path at least three times, the waste air in the waste air output path acting to warm the fresh air within the fresh air input path.

10. The method of claim of claim 9, wherein the livestock barn is a livestock poultry barn, the method further comprising:
providing a first frame configured as part of each of the plurality of tube bundle cells;
connecting the first frame to the at least four edges of the first side panels;
providing a second frame configured as part of each of the plurality of tube bundle cells; and
connecting the second frame being connected to the at least four edges of the second side panels.

11. The method of claim of claim 10, further comprising:
providing first guide grooves configured as part of the enclosure and arranged to receive and hold the first frames of the plurality of tube bundle cells, providing a substantially airtight seal between the fresh air input path and the waste air output path; and
providing second guide grooves configured as part of the enclosure and arranged to receive and hold the second frames of the plurality of tube bundle cells, providing a substantially airtight seal between the fresh air input path and the waste air output path.

12. The method of claim 11, further comprising:
providing a filter in the waste air output path at a point before waste air;
wherein the enclosure is modular and may be disassembled into a number of pieces equal to or greater than a number of tube bundle cells in the plurality of tube bundle cells.

13. The method of claim of claim 9, wherein each of the plurality of tube bundle cells comprises at least sixty-one tubes; and
wherein an average tube spacing of the at least sixty-one tubes is from 0.65 to 0.85 inches apart.

14. The method of claim of claim 9, wherein the plurality of tube bundle cells comprises tubes made from a non-metallic synthetic material.

15. The method of claim of claim 14, wherein the non-metallic synthetic material is resistant to corrosion due to poultry feces, feathers and feather parts.

16. The method of claim of claim 15, wherein the non-metallic synthetic material is resistant to corrosion due to cleaning agents and disinfectants including aldehydes, chlorine-releasing agents, iodophors, phenols and bis-phenols, quaternary ammonium compounds and peroxygens.
